(19) United States
(12) Patent Application Publication
(10) Pub. No.: US 2026/0336583 A1
(43) Pub. Date: Oct. 29, 2026

(54) BRAKE-FEEL SIMULATION DEVICE

(71) Applicant: BREMBO S.p.A., Curno (Bergamo) (IT)

(72) Inventor: Martina TRUFFELLO, Curno (Bergamo) (IT)

(73) Assignee: BREMBO S.p.A., Curno (Bergamo) (IT)

(21) Appl. No.: 18/997,249

(22) PCT Filed: Jul. 12, 2023
(86) PCT No.: PCT/IB2023/057148

§ 371 Date: Jan. 21, 2025

(30) Foreign Application Priority Data
Jul. 22, 2022 (IT) 102022000015429

(51) Int. Cl. B60T 8/40

(52) U.S. Cl. CPC B60T 8/409

(57) ABSTRACT

A braking feel simulator device for a braking system adapted to be connected to a brake pedal has at least one elastic element, a thrust piston configured to be biased against the at least one elastic element in response to an actuation of the brake pedal, and an electromechanical preloading device configured to preload the at least one elastic element.

### FIELD OF THE INVENTION

The present invention relates to a braking feel simulator device for a Brake-By-Wire (“BBW”) type braking system of vehicles with two or more wheels actuatable by a driver by means of a brake pedal or lever, and a braking system provided with such a braking feel simulator device.

### BACKGROUND ART

In braking systems of the BBW type, there is a decoupling between force and displacement imparted on the brake pedal or lever by the driver and the resulting braking force which is applied by the calipers to the vehicle wheels.

In BBW braking systems, the force and displacement imparted by the driver on the brake pedal or lever are transduced into an electrical signal which is processed by a control unit to control the actuation of the braking system calipers.

Accordingly, it is known to equip the BBW braking systems with a braking feel simulator device, referred to as a “simulator device” for brevity, connected to the brake pedal or lever and configured to simulate the feel and stiffness of a brake pedal or lever of conventional hydraulic braking systems, and thus emulate the “stiffness curve” thereof.

“Stiffness curve” means the relationship between the displacement of the brake pedal or lever along its stroke and the respective reaction force applied by the simulator device on the brake pedal or lever, and thus by the brake pedal or lever on the driver. In general, the stiffness curve has a first segment with low stiffness, a second segment with medium stiffness, and a third segment with high stiffness. Again in general terms, a steeper, “hard” stiffness curve is preferred for an “aggressive” or “sporty” driving style, while a less steep, “soft” stiffness curve is preferred for a “city” or “eco” driving style.

In the prior art, the stiffness curve of the simulator device can be designed beforehand, based on the driver's needs, so that the brake pedal or lever has the “hardness” required by the driver.

The known simulator devices comprise a plurality of elastic elements, usually coil springs, arranged in series or parallel and configured to apply, upon a tensile or compressive stress thereof, an overall reaction force, which replicates the stiffness curve of a conventional hydraulic braking system.

However, the known simulator devices do not allow modulating or adjusting the stiffness curve, and thus the “hardness” of the brake pedal or lever, without a complete redesign of the simulator device. Therefore, the known simulator devices are not customizable and adjustable to the needs of different driving styles, unless the simulator device is disassembled from the braking system and the components thereof are redesigned and replaced.

Moreover, the stiffness curve achieved by known simulator devices is subject to instabilities and variations over time, mainly due to the mechanical tolerances of the several components inside the simulator device, and in particular the tolerances of the group of springs and elastic elements arranged in series and in parallel inside the simulator device.

Moreover, the known simulator devices do not return tactile signals and feedback to the driver, such as the trembling of the brake pedal of a conventional braking system which is triggered when the ABS intervenes.

### SOLUTION

It is the object of the present invention to provide a braking feel simulator device and a braking system provided with such a simulator device, such as to obviate at least some of the drawbacks of the prior art.

It is a particular object of the present invention is to provide a simulator device configured to allow the adjustment and customization of the stiffness curve thereof without requiring a complete redesign.

It is a further particular object of the present invention to provide a simulator device, which is more stable, more efficient, and less prone to the mechanical deterioration typical of known simulator devices.

It is a further particular object of the present invention to provide a simulator device configured to return tactile signals and feedback to the driver, such as the trembling of the brake pedal of a conventional braking system which is triggered when the ABS intervenes.

These and other objects are achieved by a braking feel simulator device and a braking system provided with such a simulator device according to the independent claims.

The dependent claims relate to preferred and advantageous embodiments of the present invention.

### FIGURES

In order to better understand the invention and appreciate the advantages thereof, some non-limiting exemplary embodiments thereof will be described below with reference to the accompanying drawings, in which:

FIG. 1 diagrammatically shows a braking system comprising a braking feel simulator device, according to the prior art;

FIG. 2 diagrammatically shows a braking system comprising a braking feel simulator device, according to an embodiment of the invention;

FIG. 3 is a front perspective view of a braking feel simulator device according to an embodiment of the invention;

FIG. 4 is a rear perspective view of the braking feel simulator device shown in FIG. 3;

FIG. 5 is a side view of the braking feel simulator device shown in FIG. 4;

FIG. 6 is a longitudinal section view of a braking feel simulator device according to an embodiment of the invention;

FIG. 7 is a detail view of the braking feel simulator device shown in FIG. 6;

FIG. 8 is an exploded perspective view of a braking feel simulator device according to an embodiment of the invention;

FIG. 9 diagrammatically shows a braking system comprising a braking feel simulator device, according to a further embodiment of the invention;

FIG. 10 diagrammatically shows a braking system comprising a braking feel simulator device, according to a further embodiment of the invention;

FIG. 11 diagrammatically shows three different stiffness curves achievable by a braking feel simulator device according to the present invention.

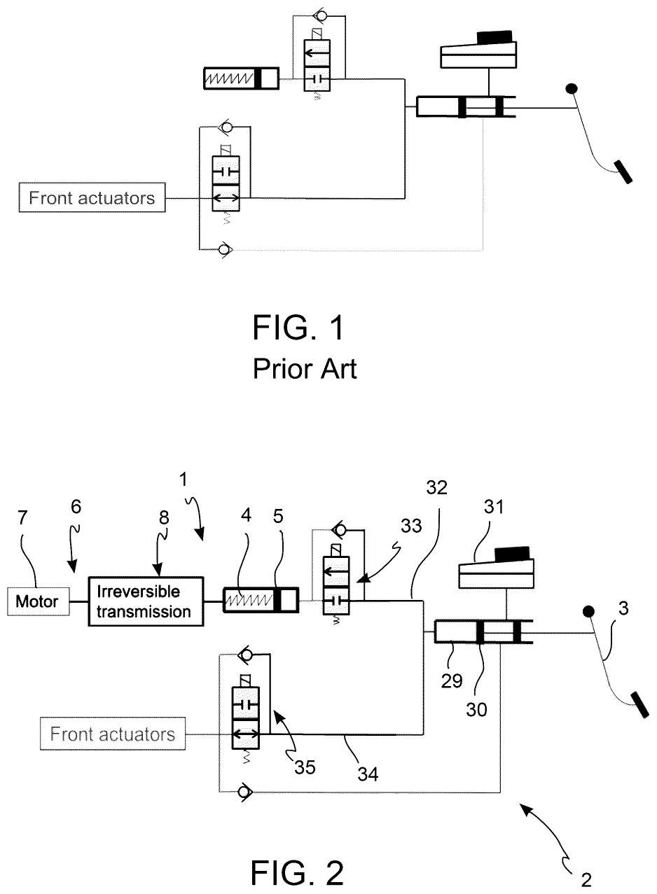

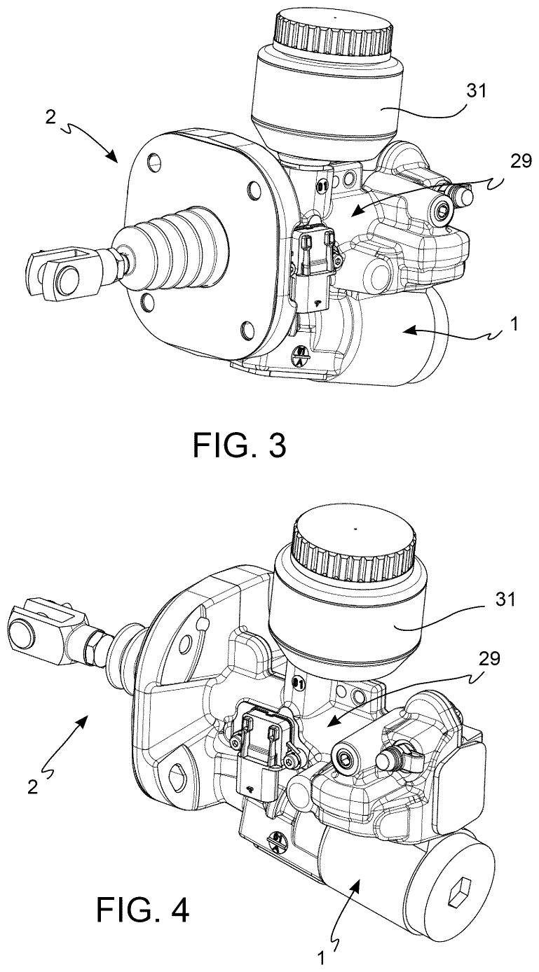

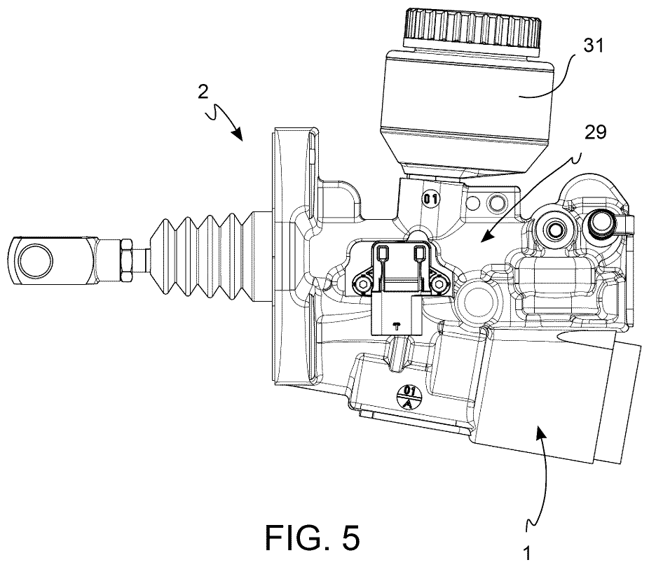

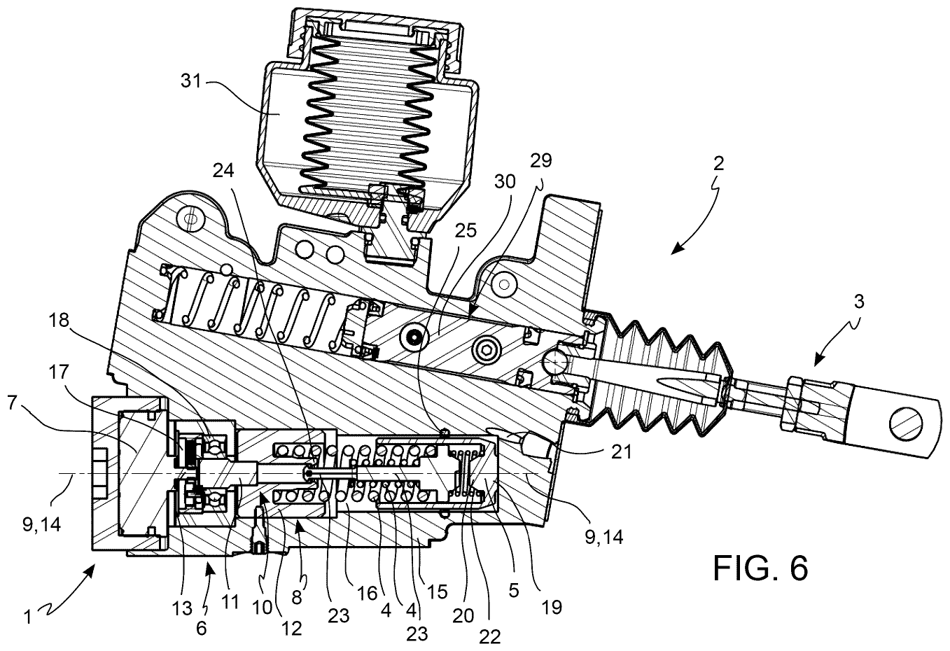

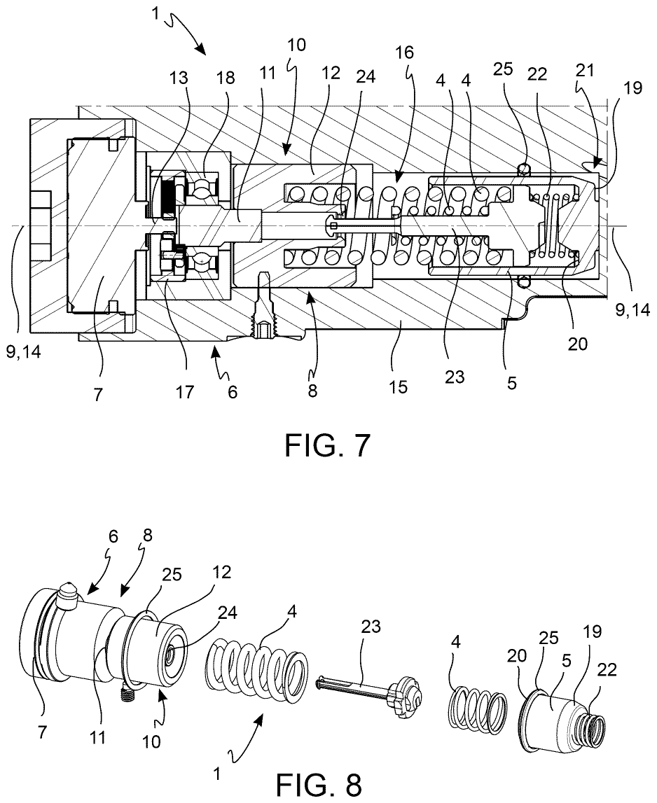

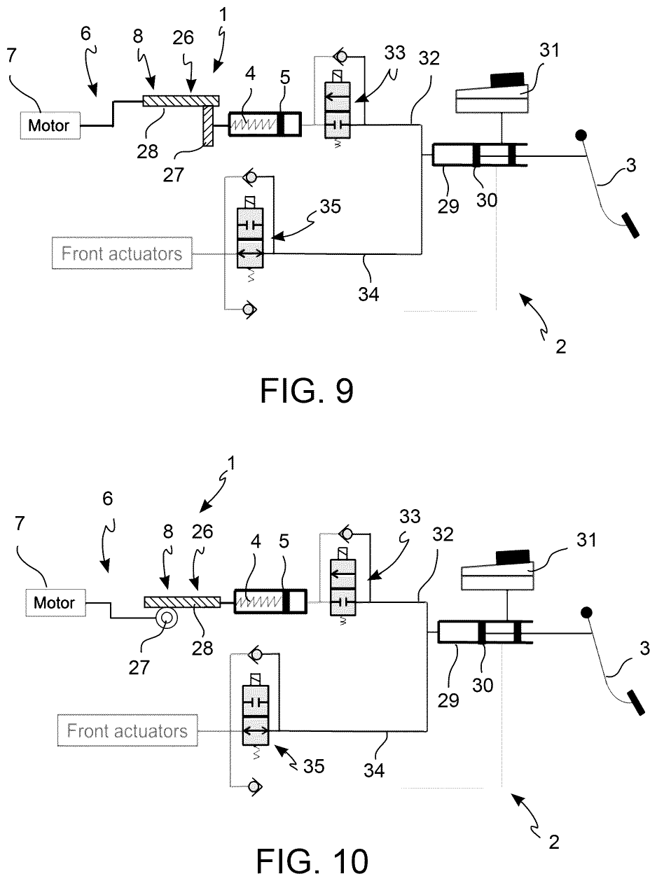

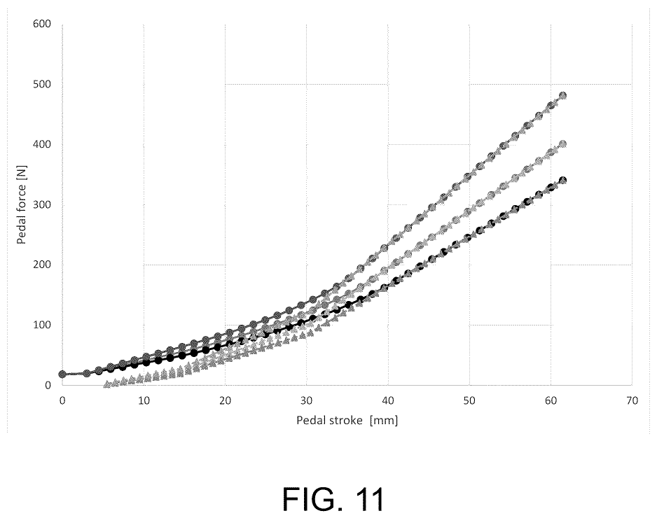

### DESCRIPTION OF SOME PREFERRED EMBODIMENTS

The present invention is suitable for being applied to a Brake-By-Wire (“BBW”) type braking system of vehicles with two or more wheels, which is actuatable by a driver by means of a brake pedal or lever. Therefore, in the present description, the term “brake pedal” means indistinctly both a brake pedal for motor vehicles and the like and a brake lever for motorcycles, mopeds, and the like, unless otherwise specified.

With reference to the figures, a braking feel simulator device is generally indicated by reference numeral 1. The braking feel simulator device 1 is adapted to be used in a braking system 2.

The braking feel simulator device 1 is adapted to be connected to a brake pedal 3.

Preferably, the braking feel simulator device 1 is adapted to be connected to a brake pedal 3 by means of a hydraulic fluid.

The braking feel simulator device 1 comprises at least one elastic element 4.

Moreover, the braking feel simulator device 1 comprises a thrust piston 5.

The thrust piston 5, is configured to be biased against the at least one elastic element 4, in response to an actuation of the brake pedal 3.

Preferably, the thrust piston 5 is configured to be biased against the at least one elastic element 4 by the hydraulic fluid, in response to an actuation of the brake pedal 3.

According to an aspect of the invention, the braking feel simulator device 1 comprises an electromechanical preloading device 6.

The electromechanical preloading device 6 is configured to preload the at least one elastic element 4.

Advantageously, a braking feel simulator device 1 thus configured allows the stiffness curve to be adjusted and customized without requiring a complete redesign.

Indeed, by means of the electromechanical preloading device 6, it is possible to adjust the preload of the at least one elastic element 4 and thus vary and adjust the “hardness” of the stiffness curve of the braking feel simulator device 1.

A higher preload of the at least one elastic element 4 corresponds to a higher resistance to the movement of the thrust piston 5 against the at least one elastic element 4, and thus a higher counteracting force on the actuation of the brake pedal 3 and a harder stiffness curve.

Conversely, a lower preload of the at least one elastic element 4 corresponds to a lower resistance to the movement of the thrust piston 5 against the at least one elastic element 4, and thus a lower counteracting force on the actuation of the brake pedal 3 and a less hard stiffness curve.

With added advantage, the braking feel simulator device 1 thus configured has a simplified structure and is more stable, more efficient, and less prone to mechanical deterioration typical of the known simulator devices.

According to an embodiment, the electromechanical preloading device 6 comprises an electric motor 7 and a preloading mechanism 8.

The preloading mechanism 8 is configured to apply a preload of the at least one elastic element 4.

The electric motor 7 is configured to actuate the preloading mechanism 8 so that the preloading mechanism 8 preloads the at least one elastic element 4.

According to an embodiment, the preloading mechanism 8 is an irreversible mechanism.

Advantageously, such a configuration prevents a retrograde motion of the preloading mechanism 8 in the absence of an actuation from the electric motor 7.

Therefore, in the absence of an actuation by the electric motor 7, the preloading mechanism 8 is configured to maintain a given preload on the at least one elastic element 4.

Conversely, a change in the preload of the at least one elastic element 4, such as a reduction or increase in the preload, requires an actuation of the preloading mechanism 8 by the electric motor 7.

Advantageously, a braking feel simulator device 1 thus configured requires less energy consumption because the irreversibility of the preloading mechanism 8 does not require a constant actuation of the electric motor 7 in order to ensure and preserve a given preload level of the at least one elastic element 4.

With further advantage, the braking feel simulator device 1 thus configured allows providing tactile signals and feedback to the driver, such as the trembling of the brake pedal of a conventional braking system which is triggered when the ABS intervenes. This is achieved by the action of the electric motor 7, configured to vary, by means of the preloading mechanism 8, the preload acting on the at least one elastic element 4. Such a change in the preload is then transmitted to the brake pedal 3, so as to obtain the desired tactile signals or vibrations.

According to an embodiment, the at least one elastic element 4 is positioned interposed between the thrust piston 5 and the electromechanical preloading device 6.

According to an embodiment, the at least one elastic element 4 is positioned interposed between the thrust piston 5 and the preloading device 8.

According to an embodiment, the at least one elastic element 4 comprises a first end and a second end opposite to the first end. The first end of the at least one elastic element 4 is positioned abutting against the thrust piston 5 and the second end of the at least one elastic element 4 is positioned abutting against the preloading mechanism 8.

### Screw-Nut Screw Assembly 10

According to an embodiment, the preloading mechanism 8 is a screw-nut screw assembly 10.

The screw-nut screw assembly 10 faces the at least one elastic element 4.

Moreover, the screw-nut screw assembly 10 is coaxial to an actuation axis 9.

The screw-nut screw assembly 10 comprises a screw 11 and a nut screw 12.

The screw 11 and the nut screw 12 are connected to each other so that a relative translation of the nut screw 12 with respect to the screw 11 along the actuation axis 9 corresponds to a relative rotation of the screw 11 with respect to the nut screw 12 about the actuation axis 9.

The electric motor 7 comprises a drive shaft 13 extending along a motor axis 14.

The screw-nut screw assembly 10 is connected to the drive shaft 13.

The electric motor 7 is configured to apply a mechanical torque on at least one of the screw 11 and the nut screw 12 so as to translate at least one of the screw 11 and the nut screw 12 either towards or away from the thrust piston 5, along the actuation axis 9 so as to either increase or decrease the preload of the at least one elastic element 4.

Specifically, a translation of the screw 11 or the nut screw 12 towards the thrust piston 5 corresponds to an increase in the preload of the at least one elastic element 4 interposed between the screw-nut screw assembly 10 and the thrust piston 5.

Vice versa, a translation of the screw 11 or the nut screw 12 towards the thrust piston 5 corresponds to a decrease in the preload of the at least one elastic element 4 interposed between the screw-nut screw assembly 10 and the thrust piston 5.

According to an embodiment, the braking feel simulator device 1 comprises a housing wall 15 extending along the actuation axis 9.

The housing wall 15 defines a housing compartment 16 therein.

The screw-nut screw assembly 10 is housed inside the housing compartment 16.

According to an embodiment, the screw 11 of the screw-nut screw assembly 10 is connected to the drive shaft 13 of the electric motor 7 so that the screw 11 is configured to receive a mechanical torque from the electric motor 7.

The screw 11 is configured to rotate with respect to the housing wall 15, but not to translate with respect to the housing wall 15.

Moreover, the nut screw 12 of the screw-nut screw assembly 10 is configured to translate along the actuation axis 9 with respect to the housing wall 15, but not to rotate with respect to the housing wall 15.

Moreover, the nut screw 12 is configured to translate either towards or away from the thrust piston 5, along the actuation axis 9, so as to either increase or decrease the preload of the at least one elastic element 4.

Specifically, a translation of the nut screw 12 towards the thrust piston 5 corresponds to an increase in the preload of the at least one elastic element 4 interposed between the nut screw 12 and the thrust piston 5.

Conversely, a translation of the nut screw 12 away from the thrust piston 5 corresponds to a decrease in the preload of the at least one elastic element 4 interposed between the nut screw 12 and the thrust piston 5.

According to this embodiment, the first end of the at least one elastic element 4 abuts against the thrust piston 5, and the second end of the at least one elastic element 4 abuts against the nut screw 12.

According to an alternative embodiment, the nut screw 12 of the screw-nut screw assembly 10 is connected to the drive shaft 13 of the electric motor 7 so that the nut screw 12 is configured to receive a mechanical torque from the electric motor 7.

The nut screw 12 is configured to rotate with respect to the housing wall 15, but not to translate with respect to the housing wall 15.

Moreover, the screw 11 of the screw-nut screw assembly 10 is configured to translate along the actuation axis 9, with respect to the housing wall 15 but not to rotate with respect to the housing wall 15.

Moreover, the screw 11 is configured to translate either towards or away from the thrust piston 5, along the actuation axis 9, so as to either increase or decrease the preload of the at least one elastic element 4.

Specifically, a translation of the screw 11 towards the thrust piston 5 corresponds to an increase in the preload of the at least one elastic element 4 interposed between the screw 11 and the thrust piston 5.

Conversely, a translation of the screw 11 away from the thrust piston 5 corresponds to a decrease in the preload of the at least one elastic element 4 interposed between the screw 11 and the thrust piston 5.

According to this embodiment, the first end of the at least one elastic element 4 abuts against the thrust piston 5, and the second end of the at least one elastic element 4 abuts against the screw 11.

According to an embodiment, the thread of the screw-nut screw assembly 10 is of the irreversible type.

The preload of the at least one elastic element 4, implemented by the nut screw 12, or by the screw 11 abutting against the at least one elastic element 4, is thus preserved even in the absence of an actuation from the electric motor 7.

According to an embodiment, the screw-nut screw assembly 10 and the electric motor 7 are positioned so that the actuation axis 9 coincides with the motor axis 14.

According to an embodiment, the electric motor 7 is positioned opposite to the thrust piston 5 with respect to the screw-nut screw assembly 10.

Advantageously, such a configuration ensures integrity and structural strength of the braking feel simulator device 1.

According to an embodiment, the nut screw 12 is positioned opposite to the electric motor 7 with respect to the screw 11.

Advantageously, such a configuration reduces the overall strains to which the braking feel simulator device 1 is subjected during the operation thereof.

According to an embodiment, the braking feel simulator device 1 comprises a transmission 17.

The transmission 17 is interposed between the electric motor 7 and the preloading mechanism 8.

IBy way of example, the transmission 17 is an epicyclic transmission, a harmonic or cycloidal reduction gear, or a cascading gear distribution.

According to an embodiment, the braking feel simulator device 1 comprises a bearing 18 interposed between the electric motor 7 and the preloading mechanism 8.

Preferably, the bearing 18 is a bearing of the thrust type. Preferably, the bearing 18 is a ball or roller type bearing.

According to an embodiment, the transmission 17 is interposed between the bearing 18 and the preloading mechanism 8.

According to an embodiment, the at least one elastic element 4 is positioned inside the housing compartment 16.

The at least one elastic element 4 is configured to apply a reaction force in response to an actuation of the braking feel simulator device 1. Specifically, the at least one elastic element 4 is configured to apply a reaction force on the thrust piston 5 actuatable in translation against the at least one elastic element 4 in response to an actuation of the brake pedal 3 by a driver. Therefore, the at least one elastic element 4 is configured to apply a reaction force on the brake pedal 3 in response to an actuation of the brake pedal 3 by a driver.

According to an embodiment, the at least one elastic element 4 is configured to be biased along a direction substantially parallel to the actuation axis 9. Preferably, the at least one elastic element 4 is configured to be biased along a direction substantially coinciding with the actuation axis 9.

Moreover, the at least one elastic element 4 is configured to bias the thrust piston 5 towards its resting position.

Therefore, during the operation of the braking feel simulator device 1, the thrust piston 5 is moved from its resting position against the at least one elastic element 4. When the operation of the braking feel simulator device 1 is interrupted, the at least one elastic element 4 biases the thrust piston 5 back to its resting position.

According to an embodiment, the at least one elastic element 4 comprises at least one compression coil spring positioned substantially coaxial to the actuation axis 9.

According to an embodiment, a first end of the at least one compression coil spring is positioned abutting against the thrust piston 5, and a second end of the at least one compression coil spring is positioned abutting against the electromechanical preloading device 6, preferably against the mechanism 8, preferably against the screw-nut screw assembly 10, more preferably against the nut screw 12, or against the screw 11, or against a worm screw 28, or against a toothed wheel 27.

According to an embodiment, the braking feel simulator device 1 comprises a plurality of elastic elements 4 positioned in series and/or in parallel inside the braking feel simulator device 1, and preferably inside the housing compartment 16.

According to an embodiment, the plurality of elastic elements 4 comprises coil springs and/or square springs and/or torsion springs and/or strip springs and/or shaped springs.

According to an embodiment, the thrust device 5 forms a blind piston cavity. The blind piston cavity is open in the direction of the preloading mechanism 8.

According to an embodiment, the first end of the at least one elastic element 4 is housed inside the blind piston cavity.

According to an embodiment, the thrust device 5 comprises a biasing wall 19.

The biasing wall faces the at least one elastic element 4 to be opposite thereto.

The biasing wall is substantially transverse to the actuating wall 9.

The thrust piston 5 is configured to receive on the biasing wall 19 a bias of a hydraulic fluid adapted to move the thrust piston 5 in translation towards the at least one elastic element 4.

The biasing wall 19 faces a conveying pipe 21.

The conveying pipe 21 is configured to fluidically connect the braking feel simulator device 1 to the brake pedal 3 by means of the hydraulic fluid.

Specifically, the conveying pipe 21 is configured to convey the hydraulic fluid into the braking feel simulator device 1 when the brake pedal 3 is actuated, and to discharge the hydraulic fluid from the braking feel simulator device 1 when the brake pedal 3 is released.

Preferably, the conveying pipe 21 at least partially defined by the housing wall 15.

According to an embodiment, the braking feel simulator device 1 comprises at least one auxiliary elastic element 22.

The at least one auxiliary elastic element 22 is interposed between the thrust piston 5 and the conveying pipe 21.

The at least one auxiliary elastic element 22 is positioned abutting against the thrust piston 5.

Advantageously, the at least one auxiliary elastic element 22 is configured to prevent the thrust piston 5, in the absence of actuation by the brake pedal 3, from impacting against the conveying pipe 21 under the bias of the at least one elastic element 4.

According to an embodiment, the at least one auxiliary elastic element 22 comprises at least one compression coil spring positioned substantially coaxial to the actuation axis 9.

According to this embodiment, a first end of the at least one compression coil spring is positioned abutting against the thrust piston 5, specifically against the biasing wall 19, and a second end of the at least one compression coil spring is positioned abutting against the housing wall 15 which forms the conveying pipe 21.

According to an embodiment, the braking feel simulator device 1 comprises a plurality of auxiliary elastic elements 22 positioned in series and/or in parallel inside the braking feel simulator device 1.

According to an embodiment, the plurality of auxiliary elastic elements 22 comprises coil springs and/or square springs and/or torsion springs and/or strip springs and/or shaped springs.

Moreover, the thrust piston 5 comprises a thrust wall 20 opposite to the biasing wall 19.

The thrust wall 20 faces the at least one elastic element 4. Specifically, the first end of the at least one elastic element 4 is positioned abutting against the thrust wall 20.

According to an embodiment, the thrust piston 5 comprises a guide rod 23 extending in a direction parallel to the actuation axis 9.

Preferably, the guide rod 23 extends along the actuation axis 9.

Preferably, the guide rod 23 is connected to the thrust wall 20 of the thrust piston 5.

According to this embodiment, the nut screw 12 forms a through-hole 24 at the guide rod 23. Preferably, the through-hole 24 is coaxial to the actuation axis 9.

The guide rod 23 is positioned passing through the through-hole 24 of the nut screw 12.

The guide rod 23 and the nut screw 12 thus achieve a geometric coupling.

The guide rod 23 is configured to translate, on the translation of the thrust piston 5, along the actuation axis 9 through the through-hole 24 of the nut screw 12.

Advantageously, the geometric coupling between the guide rod 23 and the nut screw 12 ensures a correct orientation of the thrust piston 5 inside the braking feel simulator device 1, and in particular with respect to the screw-nut screw assembly 10, avoiding misalignments or misplacements which would cause increased stresses and risks of damage and wear to the braking feel simulator device 1.

According to an embodiment, the at least one elastic element 4 is positioned substantially coaxially to the guide rod 23.

According to an embodiment, the at least one auxiliary elastic element 22 is interposed between the thrust piston 5 and the guide rod 23.

According to this embodiment, the at least one auxiliary elastic element 22 is configured to bias the guide rod 23 away from the thrust piston 5.

Advantageously, the at least one auxiliary elastic element 22 prevents the thrust piston 5 biased by the hydraulic fluid from suddenly impacting against the guide rod 23, with risk of damaging such components. Conversely, the at least one auxiliary elastic element 22 is configured to accommodate the movement, approach, and relative contact between the thrust piston 5 and the guide rod 23.

According to an embodiment, the braking feel simulator device 1 comprises at least one hydraulic seal 25.

The at least one hydraulic seal 25 is positioned at the preloading piston 5 and is configured to prevent leakages of hydraulic fluid towards the at least one elastic element 4 and the electromechanical preloading device 6.

Specifically, the at least one hydraulic seal 25 is interposed between the thrust piston 5 and the housing wall 15.

Advantageously, by means of the at least one hydraulic seal 25, the hydraulic fluid is confined within the braking feel simulator device 1 in a space between the conveying pipe 21 and the biasing wall 19 of the thrust piston 5.

According to an embodiment, the at least one hydraulic seal 25 is positioned at the preloading mechanism 8 and is configured to prevent hydraulic fluid leakages towards the at least one elastic element 4 and the electromechanical preloading device 6.

Specifically, the at least one hydraulic seal 25 is interposed between the preloading mechanism 8 and the housing wall 15.

### Worm Screw Gear 26

According to an alternative embodiment, the preloading mechanism 8 is a worm screw gear 26.

The worm screw gear 26 faces the at least one elastic element 4.

The worm screw gear 26 comprises a toothed wheel 27 and a worm screw 28.

The worm screw 28 extends along an actuation axis 9.

The toothed wheel 27 is either coaxial to an axis parallel to the actuation axis 9 or is coaxial to an axis transverse to the actuation axis 9 and substantially extends on a plane passing through the worm screw 28 and the actuation axis 9.

The toothed wheel 27 and the worm screw 28 are connected to each other so that a relative rotation of the worm screw 28 with respect to the toothed wheel 27 about the actuation axis 9 corresponds to a relative translation of the worm screw 28 with respect to the toothed wheel 27 along the actuation axis 9.

The electric motor 7 comprises a drive shaft 13 extending along a motor axis 14.

The worm screw gear 26 is connected to the drive shaft 13.

The electric motor 7 is configured to apply a mechanical torque on at least one of the toothed wheel 27 and the worm screw 28, so as to translate at least one of the toothed wheel 27 and the worm screw 28 either towards or away from the thrust piston 5, along an axis parallel to the actuation axis 9, so as to either increase or decrease the preload of the at least one elastic element 4.

Specifically, a translation of the toothed wheel 27 or worm screw 28 towards the thrust piston 5 corresponds to an increase in the preload of the at least one elastic element 4 interposed between the worm screw gear 26 and the thrust piston 5.

Conversely, a translation of the toothed wheel 27 or worm screw 28 away from the thrust piston 5 corresponds to a decrease in the preload of the at least one elastic element 4 interposed between the worm screw gear 26 and the thrust piston 5.

According to an embodiment, the braking feel simulator device 1 comprises a housing wall 15 extending along the actuation axis 9.

The housing wall 15 defines a housing compartment 16 therein.

The worm screw gear 26 is housed inside the housing compartment 16.

According to an embodiment, the toothed wheel 27 of the worm screw gear 26 is connected to the drive shaft 13 of the electric motor 7 so that the toothed wheel 27 is configured to receive a mechanical torque from the electric motor 7.

The toothed wheel 27 is configured to rotate with respect to the housing wall 15, but not to translate with respect to the housing wall 15.

Moreover, the worm screw 28 of the worm screw gear 26 is configured to translate along the actuation axis 9 with respect to the housing wall 15 but not to rotate with respect to the housing wall 15.

Moreover, the worm screw 28 is configured to translate either towards or away from the thrust piston 5, along the actuation axis 9, so as to either increase or decrease the preload of the at least one elastic element 4.

Specifically, a translation of the worm screw 28 towards the thrust piston 5 corresponds to an increase in the preload of the at least one elastic element 4 interposed between the worm screw 28 and the thrust piston 5.

Conversely, a translation of the worm screw 28 away from the thrust piston 5 corresponds to a decrease in the preload of the at least one elastic element 4 interposed between the worm screw 28 and the thrust piston 5.

According to this embodiment, the first end of the at least one elastic element 4 abuts against the thrust piston 5, and the second end of the at least one elastic element 4 abuts against the worm screw 28.

According to an alternative embodiment, the worm screw 28 of the worm screw gear 26 is connected to the drive shaft 13 of the electric motor 7 so that the worm screw 28 is configured to receive a mechanical torque from the electric motor 7.

The worm screw 28 is configured to rotate with respect to the housing wall 15 but to not to translate with respect to the housing wall 15.

Moreover, the toothed wheel 27 of the worm screw gear 26 is configured to translate along the actuation axis 9 with respect to the housing wall 15 but not to rotate with respect to the housing wall 15.

Moreover, the toothed wheel 27 is configured to translate either towards or away from the thrust piston 5, along the actuation axis 9, so as to either increase or decrease the preload of the at least one elastic element 4.

Specifically, a translation of the toothed wheel 27 towards the thrust piston 5 corresponds to an increase in the preload of the at least one elastic element 4 interposed between the toothed wheel 27 and the thrust piston 5.

Conversely, a translation of the toothed wheel 27 away from the thrust piston 5 corresponds to a decrease in the preload of the at least one elastic element 4 interposed between the toothed wheel 27 and the thrust piston 5.

According to this embodiment, the first end of the at least one elastic element 4 abuts against the thrust piston 5, and the second end of the at least one elastic element 4 abuts against the toothed wheel 27.

According to this embodiment, the toothed wheel 27 is coaxial to an axis parallel to the actuation axis 9.

According to an embodiment, the thread of the worm screw gear 26 is of the irreversible type.

The preload of the at least one elastic element 4, implemented by the worm screw 28 abutting against the at least one elastic element 4, or by the toothed wheel 27 abutting against the at least one elastic element 4, is thus preserved even in the absence of an actuation from the electric motor 7.

According to an embodiment, the worm screw gear 26 and the electric motor 7 are positioned so that the actuation axis 9 coincides with the motor axis 14.

### Braking System 2

According to a further aspect of the invention, a braking system 2 comprises a braking feel simulator device 1 as described above.

Moreover, the braking system 2 comprises a brake pedal 3 operatively connected to the braking feel simulator device 1.

According to an embodiment, the braking system 2 comprises an electronic processing unit electrically connected to the electromechanical preloading device 6 of the braking feel simulator device 1.

The electronic processing unit is configured to operate the electromechanical preloading device 6 so as to obtain a given preload of the at least one elastic element 4.

Specifically, the electronic processing unit is configured to control the braking feel simulator device 1 to obtain a stiffness curve selectable from a plurality of stiffness curves.

According to this embodiment, each selectable stiffness curve corresponds to a given preload value of the at least one elastic element 4 which can be implemented by the electromechanical preloading device 6.

According to an embodiment, the braking system 2 comprises at least one sensor.

The sensor is configured to detect, either directly or indirectly, the mechanical torque applied by the electric motor 7.

Alternatively or additionally, the sensor is configured to detect, either directly or indirectly, a translation or the position of nut screw 12 or screw 11 or worm screw 28 or toothed wheel 27 along the actuation axis 9.

According to an embodiment, the braking system 2 comprises a selection device connected to the electronic processing unit.

The selection device is configured to allow a driver to select a stiffness curve from a plurality of predetermined stiffness curves of the braking feel simulator device 1.

According to an embodiment, each selectable stiffness curve corresponds to a given value of mechanical torque applied by the electric motor 7 or corresponds to a given translation or position of nut screw 12 or screw 11 or worm screw 28 or toothed wheel 27 along the actuation axis 9.

According to an embodiment, the braking system 2 is configured to obtain at least two, preferably at least three, different stiffness curves.

The stiffness curves differ in their different steepness, and thus in the different hardness perceivable by the driver operating the brake pedal 3.

By way of example, a driver can choose from three different stiffness curves, referred to as “sport,” “drive,” and “city,” for example, depending on the respective hardness.

According to an embodiment, the braking system 2 comprises a master cylinder 29 connected to the brake pedal 3.

The master cylinder 29 comprises a float 30, which is set in motion by the driver's mechanical action on the brake pedal 3. The float 30 has the function of pressurizing the hydraulic fluid.

Moreover, the hydraulic fluid is contained in a reservoir 31 fluidically connected to the master cylinder 29.

The master cylinder 29 is fluidically connected, by means of a first hydraulic duct 32 containing hydraulic fluid, to the braking feel simulator device 1.

According to an embodiment, a first on-off valve 33 is arranged along the first hydraulic duct 32. The on-off valve 33 can be opened and closed; in the open configuration, it allows the fluid connection between the master cylinder 29 and the braking feel simulator device 1; in the closed configuration, it disconnects the braking feel simulator device 1 from the master cylinder 29.

According to an embodiment, the braking system 2 further comprises a second hydraulic duct 34 operatively connected to at least one braking device associated with a wheel of a vehicle.

The second hydraulic duct 34 is connected to the first hydraulic duct 32 by means of a second on-off valve 35.

The second on-off valve 35 can be, in turn, open and closed; in the open configuration, the second on-off valve 35 allows fluid connection between the master cylinder 29 and the braking device, so that the driver can directly operate the braking device with a conventional hydraulic actuation by acting on the brake pedal 3. In the closed configuration, the second on-off valve 35 prevents the direct hydraulic connection between the master cylinder 29 and the braking device. Therefore, the second hydraulic conduit 34 acts as a backup in case of malfunction or power failure of the electric actuation means.

Obviously, those skilled in the art will be able to make changes or adaptations to the present invention, without however departing from the scope of the following claims.

### LIST OF REFERENCE NUMERALS

1. Braking feel simulator device
2. Braking system
3. Brake pedal
4. Elastic element
5. Thrust piston
6. Electromechanical preloading device
7. Electric motor
8. Preloading mechanism
9. Actuation axis
10. Screw-nut screw assembly
11. Screw
12. Nut screw
13. Drive shaft
14. Drive axis
15. Housing wall
16. Housing compartment
17. Transmission
18. Bearing
19. Biasing wall
20. Thrust wall
21. Conveying pipe
22. Auxiliary elastic element
23. Guide rod
24. Through-hole
25. Hydraulic seal
26. Worm screw gear
27. Toothed wheel
28. Worm screw
29. Master cylinder
30. Float
31. Reservoir
32. First hydraulic duct
33. First on-off valve
34. Second hydraulic duct
35. Second on-off valve

1-18. (canceled)

19. A braking feel simulator device for a braking system, the braking feel simulator device being adapted to be connected to a brake pedal,
wherein the braking feel simulator device comprises:
at least one elastic element;
a thrust piston configured to be biased against the at least one elastic element, in response to an actuation of the brake pedal; and
an electromechanical preloading device configured to preload the at least one elastic element.

20. The braking feel simulator device of claim 19, wherein the electromechanical preloading device comprises an electric motor and a preloading mechanism, wherein the preloading mechanism is configured to apply a preload on the at least one elastic element, wherein the electric motor is configured to actuate the preloading mechanism so that the preloading mechanism preloads the at least one elastic element, wherein the preloading mechanism is an irreversible mechanism, and wherein, optionally, the at least one elastic element is interposed between the thrust piston and the electromechanical preloading device.

21. The braking feel simulator device of claim 19, wherein the electromechanical preloading device comprises an electric motor and a preloading mechanism, wherein the preloading mechanism is configured to apply a preload on the at least one elastic element, wherein the electric motor is configured to actuate the preloading mechanism so that the preloading mechanism preloads the at least one elastic element,
wherein the preloading mechanism is a screw-nut screw assembly,
wherein the screw-nut screw assembly faces the at least one elastic element and is coaxial to an actuation axis,
wherein the screw-nut screw assembly comprises a screw and a nut screw,
wherein the screw and the nut screw are connected to each other so that a relative translation of the nut screw with respect to the screw along the actuation axis corresponds to a relative rotation of the screw with respect to the nut screw about the actuation axis,
wherein the electric motor comprises a drive shaft extended along a motor axis and the screw-nut screw assembly is connected to the drive shaft, and
wherein the electric motor is configured to apply a mechanical torque on at least either the screw or the nut screw so as to translate at least either the screw or the nut screw either towards or away from the thrust piston, along the actuation axis to either increase or decrease the preload of the at least one elastic element.

22. The braking feel simulator device of claim 21, further comprising a housing wall extended along the actuation axis, wherein the housing wall defines a housing compartment therein, and wherein the screw-nut screw assembly is housed inside the housing compartment,
wherein the screw of the screw-nut screw assembly is connected to the drive shaft of the electric motor so that the screw is configured to receive the mechanical torque from the electric motor,
wherein the screw is configured to rotate with respect to the housing wall, but not to translate with respect to the housing wall,
wherein the nut screw of the screw-nut screw assembly is configured to translate along the actuation axis with respect to the housing wall, but not to rotate with respect to the housing wall, and
wherein the nut screw is configured to translate either towards or away from the thrust piston, along the actuation axis, to either increase or decrease the preload of the at least one elastic element.

23. The braking feel simulator device of claim 21, further comprising a housing wall extended along the actuation axis, wherein the housing wall defines a housing compartment therein, and wherein the screw-nut screw assembly is housed inside the housing compartment,
wherein the nut screw of the screw-nut screw assembly is connected to the drive shaft of the electric motor so that the nut screw is configured to receive the mechanical torque from the electric motor,
wherein the nut screw is configured to rotate with respect to the housing wall, but not to translate with respect to the housing wall,
wherein the screw of the screw-nut screw assembly is configured to translate along the actuation axis, with respect to the housing wall, but not to rotate with respect to the housing wall, and
wherein the screw is configured to translate either towards or away from the thrust piston, along the actuation axis, to either increase or decrease the preload of the at least one elastic element.

24. The braking feel simulator device of claim 21, wherein a thread of the screw-nut screw assembly is of an irreversible type.

25. The braking feel simulator device of claim 21, wherein the screw-nut screw assembly and the electric motor are positioned so that the actuation axis coincides with the motor axis, and wherein the braking feel simulator device further comprises at least one of the following features or a combination thereof:
the electric motor is positioned opposite to the thrust piston with respect to the screw-nut screw assembly,
the nut screw is positioned opposite to the electric motor with respect to the screw,
the braking feel simulator device comprises a transmission interposed between the electric motor and the preloading mechanism,
the braking feel simulator device comprises a bearing interposed between the electric motor and the preloading mechanism.

26. The braking feel simulator device of claim 25, wherein the transmission is interposed between the bearing and the preloading mechanism.

27. The braking feel simulator device of claim 19, further comprising a housing wall extended along an actuation axis, wherein the housing wall defines a housing compartment therein, and wherein the at least one elastic element is positioned inside the housing compartment,
wherein the at least one elastic element is configured to be biased along a direction substantially parallel to the actuation axis and to bias the thrust piston toward its resting position,
wherein the at least one elastic element comprises at least one compression coil spring positioned substantially coaxial to the actuation axis, wherein a first end of the at least one compression coil spring is positioned abutting against the thrust piston and a second end of the at least one compression coil spring is positioned abutting against the electromechanical preloading device,
or wherein the braking feel simulator device comprises a plurality of elastic elements positioned either in series and/or in parallel inside the housing compartment, and wherein the plurality of elastic elements comprises at least one of coil springs, square springs, torsion springs, strip springs, or shaped springs.

28. The braking feel simulator device of claim 19, wherein the at least one elastic element is configured to bias the thrust piston toward its resting position.

29. The braking feel simulator device of claim 20, wherein the thrust piston forms a piston blind cavity open in direction of the preloading mechanism, and wherein a first end of the at least one elastic element is housed within the piston blind cavity,
or wherein the thrust piston comprises a biasing wall facing opposite to the at least one elastic element, substantially transverse to an actuation axis, wherein the thrust piston is configured to receive on the biasing wall a bias of a hydraulic fluid adapted to move the thrust piston in translation towards the at least one elastic element, wherein the biasing wall faces a conveying pipe configured to fluidically connect the braking feel simulator device to the brake pedal by the hydraulic fluid, and wherein the braking feel simulator device comprises at least one auxiliary elastic element interposed between the thrust piston and the conveying pipe, wherein the at least one auxiliary elastic element is positioned abutting against the thrust piston and is configured to prevent the thrust piston in absence of the actuation of the brake pedal, from impacting against the conveying pipe under a bias of the at least one elastic element.

30. The braking feel simulator device of claim 22, wherein the thrust piston comprises a guide rod extending along the actuation axis,
wherein the nut screw forms a through-hole at the guide rod, and the through-hole is coaxial to the actuation axis,
wherein the guide rod is positioned passing through the through-hole of the nut screw, so that the guide rod and the nut screw achieve a geometric coupling, and the guide rod is configured to translate, at a translation of the thrust piston, along the actuation axis through the through-hole of the nut screw, and
wherein the braking feel simulator device optionally comprises at least one auxiliary elastic element interposed between the thrust piston and the guide rod, and the at least one auxiliary elastic element is configured to bias the guide rod away from the thrust piston.

31. The braking feel simulator device of claim 19, wherein the braking feel simulator device comprises at least one hydraulic seal positioned at the thrust piston and configured to prevent hydraulic fluid leakage toward the at least one elastic element and the electromechanical preloading device, and
wherein the braking feel simulator device comprises a housing wall extended along an actuation axis, wherein the housing wall defines therein a housing compartment, and the at least one hydraulic seal is interposed between the thrust piston and the housing wall.

32. The braking feel simulator device of claim 19, wherein the electromechanical preloading device comprises an electric motor and a preloading mechanism, wherein the preloading mechanism is configured to apply a preload on the at least one elastic element, wherein the electric motor is configured to actuate the preloading mechanism so that the preloading mechanism preloads the at least one elastic element,
wherein the preloading mechanism is a worm screw gear facing the at least one elastic element,
wherein the worm screw gear comprises a toothed wheel and a worm screw,
wherein the worm screw extends along an actuation axis,
wherein the toothed wheel is either coaxial to an axis parallel to the actuation axis or is coaxial to an axis transverse to the actuation axis and extends on a plane passing through the worm screw and the actuation axis,
wherein the toothed wheel and the worm screw are connected to each other so that a relative rotation of the worm screw with respect to the toothed wheel about the actuation axis corresponds to a relative translation of the worm screw with respect to the toothed wheel along the actuation axis,
wherein the electric motor comprises a drive shaft extended along a motor axis,
wherein the worm screw gear is connected to the drive shaft, and
wherein the electric motor is configured to apply a mechanical torque on at least one between the toothed wheel and the worm screw, so as to translate at least either the toothed wheel or the worm screw either towards or away from the thrust piston, along an axis parallel to the actuation axis, to increase or decrease the preload of the at least one elastic element.

33. The braking feel simulator device of claim 32, further comprising a housing wall extended along the actuation axis, wherein the housing wall defines a housing compartment therein, and wherein the worm screw is housed within the housing compartment,
wherein the toothed wheel of the worm screw gear is connected to the drive shaft of the electric motor so that the toothed wheel is configured to receive the mechanical torque from the electric motor,
wherein the toothed wheel is configured to rotate with respect to the housing wall, but not to translate with respect to the housing wall,
wherein the worm screw of the worm screw gear is configured to translate along the actuation axis with respect to the housing wall but not to rotate with respect to the housing wall, and
wherein the worm screw is configured to translate either towards or away from the thrust piston, along the actuation axis, so as to either increase or decrease the preload of the at least one elastic element.

34. The braking feel simulator device of claim 32, further comprising a housing wall extended along the actuation axis, wherein the housing wall defines a housing compartment therein, and wherein the worm screw is housed within the housing compartment,
wherein the worm screw of the worm screw gear is connected to the drive shaft of the electric motor so that the worm screw is configured to receive the mechanical torque from the electric motor,
wherein the worm screw is configured to rotate with respect to the housing wall, but to not translate with respect to the housing wall,
wherein the toothed wheel of the worm screw gear is configured to translate along the actuation axis with respect to the housing wall but not to rotate with respect to the housing wall, and
wherein the toothed wheel is configured to translate either towards or away from the thrust piston, along the actuation axis, to either increase or decrease the preload of the at least one elastic element.

35. The braking feel simulator device of claim 32, wherein a thread of the worm screw gear is of an irreversible type.

36. A braking system, comprising
a braking feel simulator device adapted to be connected to a brake pedal, wherein the braking feel simulator device comprises:
at least one elastic element;
a thrust piston configured to be biased against the at least one elastic element, in response to an actuation of the brake pedal; and
an electromechanical preloading device configured to preload the at least one elastic element, and
a brake pedal operatively connected to the braking feel simulator device.

37. The braking system of claim 36, further comprising an electronic processing unit electrically connected to the electromechanical preloading device of the braking feel simulator device, wherein the electronic processing unit is configured to actuate the electromechanical preloading device to achieve a given preload of the at least one elastic element, and wherein the braking system further comprises at least one sensor configured to detect, either directly or indirectly, a mechanical torque applied by an electric motor of the electromechanical preloading device and/or a translation or a position of a nut screw or screw or worm screw or toothed wheel along an actuation axis.

38. The braking system of claim 37, further comprising a selection device connected to the electronic processing unit, wherein the selection device is configured to allow a driver to select a stiffness curve from a plurality of predetermined stiffness curves achievable by the braking feel simulator device, and wherein each stiffness curve of the plurality of predetermined stiffness curves corresponds to a given mechanical torque value applied by the electric motor, or to a given translation or position of the nut screw or screw or worm screw or toothed wheel along the actuation axis.
